(19) United States
(12) Patent Application Publication
(10) Pub. No.: US 2021/0079701 A1
(43) Pub. Date: Mar. 18, 2021

(54) HINGE SHIM AND SHEET THEREOF

(71) Applicant: Michael E. Christeson, Santa Barbara, CA (US)

(72) Inventor: Michael E. Christeson, Santa Barbara, CA (US)

(21) Appl. No.: 16/569,402

(22) Filed: Sep. 12, 2019

(51) Int. Cl. E05D 11/00; E05D 7/04

(52) U.S. Cl. CPC E05D 11/00; E05Y 2900/132; E05Y 2600/634; E05D 7/04

(57) ABSTRACT

An improved plastic hinge shim or work piece that allows for quick alignment of a door is claimed. The hinge shim is an elongated tapered hard plastic body wherein each hinge shim has transverse score lines so that segments can be broken off. Additionally, the hinge shims are molded in a sheet of a plurality of shims such that they can be folded to form a thicker hinge shim as required for application. The slots provided for the hinge mounting screws permit the hinge shim(s) to be moved further into the cavity or out toward the hinge pin to provide for finer adjustment. These hinge shims can easily slip into the cavity under the hinge without the need for trimming. Moreover, the slots for the hinge screws are open to an edge to permit the hinge shim to be inserted into the cavity without removing the screws for the hinge plate.

### RELATED APPLICATIONS

Not applicable.

### TECHNICAL FIELD

The disclosure herein relates generally to plastic hinge shims and to a sheet of such shims. More particularly, the disclosure relates to shims and methods to facilitate door mounting with use of shims and sheets therein for supporting door hinges in a manner which results in the desired alignment of the mounted door to a door jamb.

### BACKGROUND

Applicant is the named inventor of U.S. Pat. No. 7,536,747, the entire disclosure of which, are incorporated herein by reference. In the event of inconsistent usages between this document and the document so incorporated by reference, the usage in the incorporated references should be considered supplementary to that of this document; for irreconcilable inconsistencies, the usage in this document controls.

In the construction of buildings, both commercial and residential, tapered workpieces, such as shims, are commonly used. Shims are used to fill gaps and are placed under hinges to align items such as doors or windows in their jamb, or to adjust such items to fit properly. Thus, they avoid use of plane or sanding of such items, which would then require refinishing.

Wood shims have long been the material of choice in many construction projects, particularly for residences due to their availability, being inexpensive and relatively easy to work with. Conventional wood shims have certain deficiencies that provide room for improvement, however. First, wood pieces of this size can split or splinter, especially if forced into position and/or struck with a hammer or tool. Splitting or splintering can defeat the purpose of the shim and can cause safety problems. Second, the inherent properties of wood, being relatively porous, cause wood to compress, especially if substantial forces are applied against it, which can defeat the purpose of the shim. Third, as an organic material, wood can decay or degrade over time. Fourth, although relatively easy to handle and alter in size, wood shims still require tools and substantial handling, which is time-consuming.

In the past, shims were typically fashioned from cardboard boxes or nail boxes, to slip under the hinge and thus change the door's alignment to the jamb. Cardboard shims are inherently weak and expose the door to settling as the cardboard shims compress. Meanwhile, in the case of metal shims, such shims lack adjustability due to its single thickness and inflexible properties.

Shims are commonly nailed into place so as not to fall or slide, especially when an exact location often times must be maintained. Accordingly, wooden shims cannot always be held by a nail, thereby resulting in a shim that falls or will not maintain a constant location. Moreover, plastic shims can be secured firmly in place by a nail or screw without splitting or compromising its position. Due to the current molding process of plastic shims, commonly a hinge screw, screws, or pins need to be fully backed out of the hinge plate or so that a shim can be slid behind the hinge. This costs additional time and money.

In U.S. Pat. No. 5,953,862 a plastic shim is disclosed. Its shape and design are not that of the common shim acceptable for conventional construction purposes, however. In U.S. Pat. No. 6,155,004, a tapered plastic shim and a sheet of such shims is disclosed. But, such shims do not have features to move them further into a cavity under a hinge or out towards a hinge pin. Moreover, a group of such shims cannot be folded together to form a thicker shim required for application, since they cannot be readily broken lengthwise for separation or detachment from the sheet. Such shims also do not have features which allow for placement of the shim behind the hinge without first removing all the screws and pins.

What is needed is an improved workpiece, which is of uniform size and shape, of homogeneous consistency, of dependable quality, so that it does not split or break easily or unintentionally. Further needed is a shim workpiece that will easily slip into the cavity under the hinge without the need for trimming to fit into the cavity or removal of the hinge screws or pins. Further, the workpiece should be of tapered design in which either the thin or thick edge of the hinge shim can be inserted first to provide movement of the hinge pin toward or away from the doorjamb.

### SUMMARY

Certain deficiencies of the prior art are overcome by providing embodiments of an apparatus, kit, and system in accordance with the present disclosure. The present disclosure provides an improved plastic shim or workpiece useful in the construction industry. Each workpiece is a tapered hard plastic body with a thicker section and a thinner section and has special characteristics for its intended purpose. Each workpiece is slotted such that it may slip behind a hinge without the complete removal of the hinge screws upon the shim being folded or separated. The workpieces are manufactured to be of uniform size and shape, of homogeneous consistency, and of dependable quality so that they do not change with time. Moreover, they are of such dimensions, hardness, and other characteristics as are especially suited for use as a hinge shim or other workpiece and which overcome the disadvantages of other types of shims.

### BRIEF DESCRIPTION OF THE DRAWINGS

Further advantages of the present disclosure may become apparent to those skilled in the art with the benefit of the following detailed description of the preferred embodiments and upon reference to the accompanying drawings in which:

FIG. 1 is a front view of a surface of one non-limiting embodiment of a type of hinge shim in accordance with of the present disclosure;

FIG. 2 is a side view of one non-limiting embodiment of a type of hinge shim in accordance with the present disclosure;

FIG. 3 is a front view of a surface of one non-limiting embodiment of a type of hinge shim in accordance with of the present disclosure;

FIG. 4 is a side view of one non-limiting embodiment of a type of hinge shim in accordance with the present disclosure;

FIG. 5 is a front view of a surface of one non-limiting embodiment of a type of hinge shim in accordance with of the present disclosure;

FIG. 6 is a side view of one non-limiting embodiment of a type of hinge shim in accordance with the present disclosure; and

FIG. 7 is a perspective view of one non-limiting embodiment of a type hinge shim in accordance with the present disclosure.

### DETAILED DESCRIPTION OF THE PREFERRED EMBODIMENTS

Referring now to the drawings, like reference numerals designate identical or corresponding features throughout the several views. Further, described herein are certain non-limiting embodiments of a shim and sheet thereof for proper mounting of doors to respective hinges.

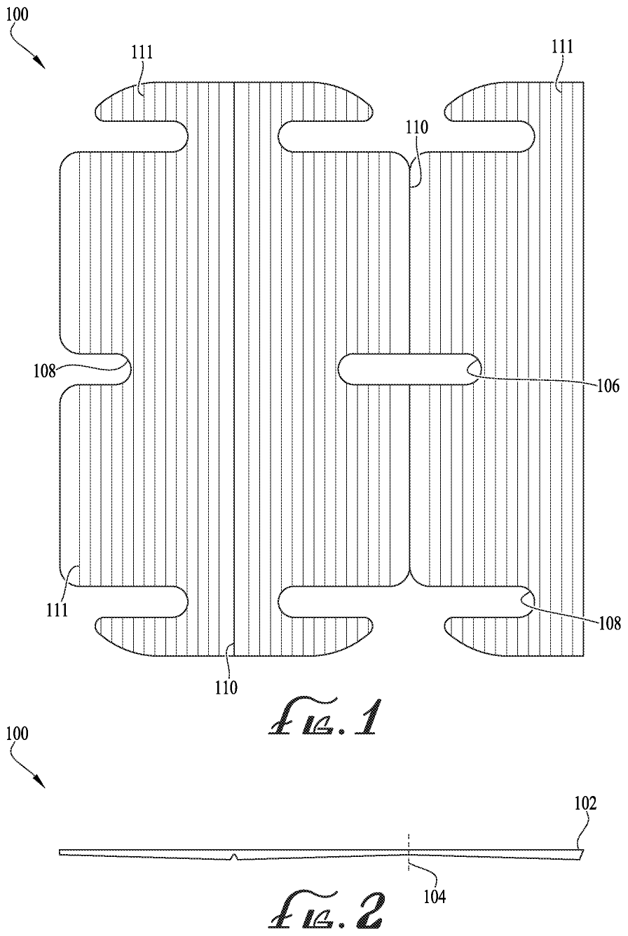

Referring to FIGS. 1-7, shown are multiple embodiments and defined as hinge shim 100, hinge shim 200, and hinge shim 300. Hinge shim 100, hinge shim 200, and hinge shim 300 represent only one variation of several potential embodiments of the disclosed hinge shim. Variations between hinge shims are introduced to the market based on variations of door hinges, as door hinges are introduced to the market. It is contemplated that the number of variety of types of hinge shims within the spirit of the present design is limited only by the number and variety of door hinges which include a bi-planer design that requires mounting to a door jamb, a hinge pin, and door.

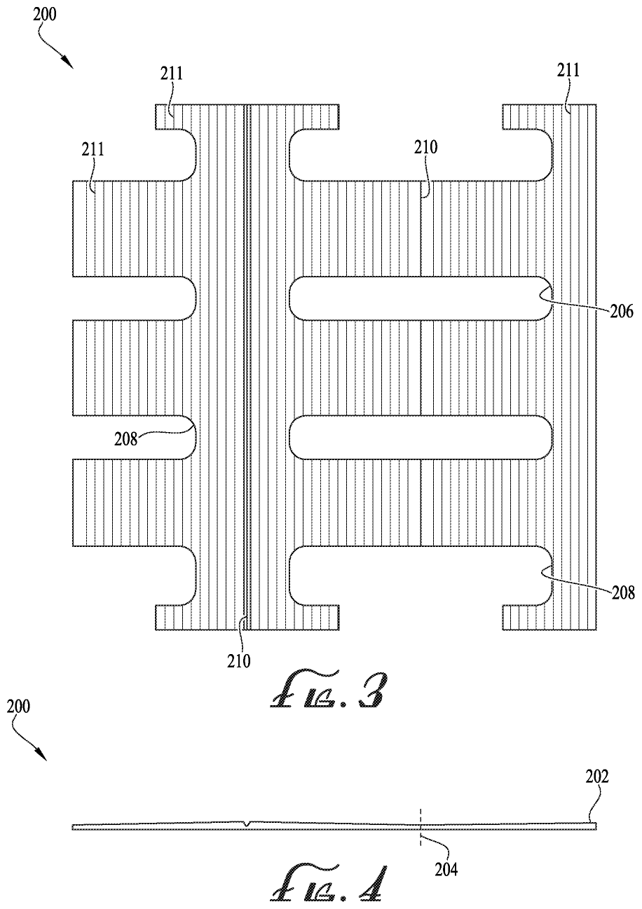

Specifically referring to FIGS. 1 and 2, shown are one potential embodiment of a hinge shim 100. FIG. 2 illustrates the tapered aspect of the hinge shim 100. Shown is a gradually and uniformly, linearly tapered aspect from a thicker section 102 to a thinner section 104. The thinner section 104 may be further defined by the thinness and nearly sharp edge. No discrete boundary between thicker section 102 and thinner section 104 may exist.

Further illustrated in FIG. 1 are slots 106, open slots 108, and score lines 110. Where any two of the thicker section 102 and thinner section 104 may meet, a score line 110 may be further defined. The score lines 110 may further indicate where a boundary area between two shim 100 may exist. However, a user is free to create an impromptu score line at any point along the width of the shim 100 by using the reference line 111 as a reference point. Thus, the reference line 111 may guide a user of shim 100 to make a more appropriately sized shim 100 for any one individual hinge by guiding a user of shim 100 to cut or fold at any reference line 111 or between any reference line 111. Thus, reference line 111 may be located at any particular location along the width of the hinge shim 100 provided, and to aid in, enabling the hinge shim 100 to accurately align a hinge to a door jamb (not shown).

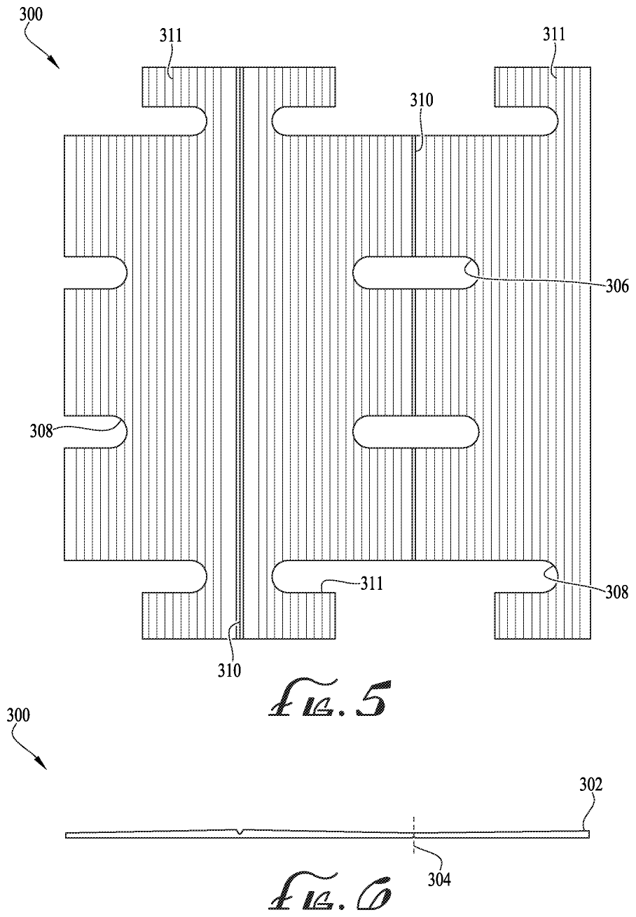

Specifically referring to FIGS. 3 and 4, shown are one potential embodiment of a hinge shim 200. FIG. 4 illustrates the tapered aspect of the hinge shim 200. Shown is a gradually and uniformly, linearly tapered aspect from a thicker section 202 to a thinner section 204. The thinner section 204 may be further defined by the thinness and nearly sharp edge. No discrete boundary between thicker section 202 and thinner section 204 may exist.

Further illustrated in FIG. 4 are slots 206, open slots 208, and score lines 210. Where any two of the thicker section 202 and thinner section 204 may meet, a score line 210 may be further defined. The score lines 210 may further indicate where a boundary area between two shim 200 may exist. However, a user is free to create an impromptu score line at any point along the width of the shim 200 by using the reference line 211 as a reference point. Thus, the reference line 211 may guide a user of shim 200 to make a more appropriately sized shim 200 for any one individual hinge by guiding a user of shim 100 to cut or fold at any reference line 211 or between any reference line 211. Thus, reference line 211 may be located at any particular location along the width of the hinge shim 200 provided, and to aid in, enabling the hinge shim 200 to accurately align a hinge to a door jamb (not shown).

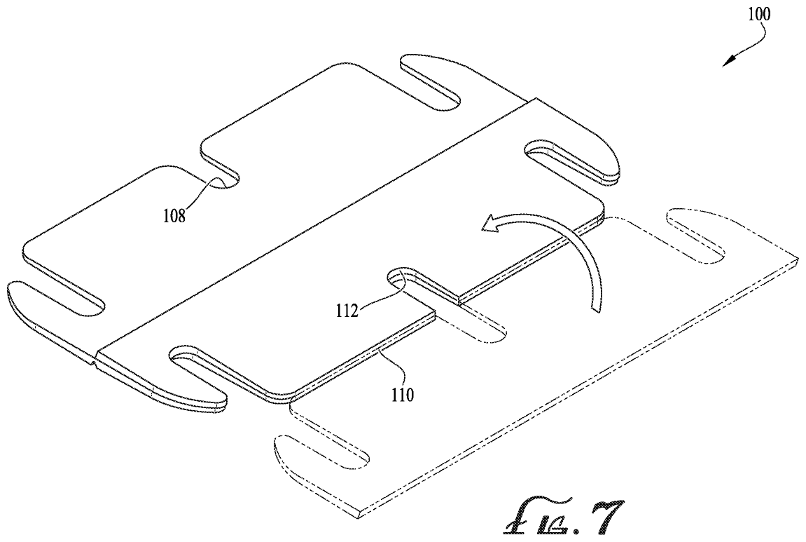

Specifically referring to FIGS. 5 and 6, shown are one potential embodiment of a hinge shim 300. FIG. 6 illustrates the tapered aspect of the hinge shim 300. Shown is a gradually and uniformly, linearly tapered aspect from a thicker section 302 to a thinner section 304. The thinner section 304 may be further defined by the thinness and nearly sharp edge. No discrete boundary between thicker section 302 and thinner section 304 may exist.

Further illustrated in FIG. 5 are slots 306, open slots 308, and score lines 310. Where any two of the thicker section 302 and thinner section 304 may meet, a score line 310 may be further defined. The score lines 310 may further indicate where a boundary area between two shim 300 may exist. However, a user is free to create an impromptu score line at any point along the width of the shim 300 by using the reference line 311 as a reference point. Thus, the reference line 311 may guide a user of shim 300 to make a more appropriately sized shim 300 for any one individual hinge by guiding a user of shim 300 to cut or fold at any reference line 311 or between any reference line 311. Thus, reference line 311 may be located at any particular location along the width of the hinge shim 300 provided, and to aid in, enabling the hinge shim 300 to accurately align a hinge to a door jamb (not shown).

Referring now to FIG. 7, shown is hinge shim 100 in a folded configuration. When folded, shim 100, along with all other shims, form a multilayered shim. The hinge shim 100 is folded along a score line 110. The folding along of score line 110 illustrates fold slot 112. Fold slot 112 may be accessed when a prospective user of an embodiment of a hinge shim as described folds a hinge shim 100, 200, or 300 along a score line 110, 210, or 310. It should be noted that a fold slot 112 as described herein is not limited to hinge shim 100, nor is may it be limited to hinge shim 200 or 300, rather the fold slot 112 is contemplated to operate in the same manner with any patterned designed slots. Moreover, shim 100 need not be folded at score line 110 for the fold slot 112 to be open at one end. The user of shim 100 may alternatively separate the shim 100 at score line 110, resulting in fold slot 112 being open at one end as well. The embodiments indicated as hinge shim 100, hinge shim 200, and hinge shim 300 are not limiting, and the variation of a contemplated hinge shim is limited only by the variations available from door hinges which include a bi-planer design that requires mounting to a door jamb, hinge pin, and door (not shown).

Having disclosed the structure of the preferred embodiments, it is now possible to describe its function, operation, and use. The present disclosure provides an improved plastic hinge shim or work piece useful in the construction industry. The work pieces are of uniform size and shape, of homogeneous consistency, and of dependable quality, so that they do not change with time. Moreover, they are of such dimensions, hardness, and other characteristics as are especially suited for use as a hinge shim or other work piece and which overcome the disadvantages of other types of shims.

The slots permit the shim 100, shim 200, or shim 300 to be moved further into the cavity or out toward the hinge's pin to provide a finer adjustment of the door alignment. Each hinge shim has transverse break lines, or score line 110, score line 210, or score line 310 so that segments can be broken off. Additionally, the hinge shims are molded in a sheet of work pieces such that they can be folded to form a thicker hinge shim as required for application. The hinge shims help in quick alignment of the door in the jamb and avoid the requirement of finishing as a result of sanding or planning. When folded into a group of two or three shims, the fold slot 112, open slot 108, and slot 106 may be aligned with each other for ease of inserting the screws. Moreover, when folded or separated, shim 100, shim 200, or shim 300 may cause for slot 106, 206, or 306 to be open to an edge of shim 100, shim 200, or shim 300. When folded or separated, fold slot 112, and in combination with all other slots, may be moved behind a door hinge without removing the screws of the hinges to the door jamb. Shim 100, shim 200, or shim 300 may be separated by pulling or cutting.

The shim may be molded of plastic material, such as polystyrene, polypropylene or high impact polystyrene, that is hard, durable, of high strength and impact resistance, and of homogeneous consistency. The shim 100, shim 200, or shim 300 may have opposite, flat, rectangular front and back shimming surfaces. Additionally, the shim may be molded as one piece.

Each shim 100, shim 200, or shim 300 may have transverse breakable means on the thicker and thinner sections and on the opposite surfaces of each work piece. Additionally, the shim 100, shim 200, or shim 300 are molded in a sheet of three shims joined such that they can be folded to form a thicker shim as required for the application. Thus, they can be used as single or as a pair or as three folded together, forming the thickness of shim required for the application.

The tapered design of the hinge shim 100, shim 200, or shim 300, having thinner and thicker sections may be contemplated to provide additional movement of the door in the jamb for a given thickness. The thinner edges may be adequately described as acuate. Thus, a hinge shim thickness of 0.050 inches at the thick end will displace the hinge pin approximately 0.060 inches. This additional movement may be due to the tapered design of the shim. Additionally, the thinnest section of the shim 100, shim 200, or shim 300 may typically be placed furthest into the cavity under the hinge, thus minimizing the amount of lifting of the hinge at the edge mortised into the door's jamb. This provides a more aesthetically pleasing appearance than a shim of constant thickness, as the shim of constant thickness displaces the edge of the hinge above the surface of the jamb by the amount of the shim thickness.

The shims may be designed and manufactured, slightly smaller than the hinge itself and may have a rounded corner to the thin edge 104. Moreover, this rounded corner may permit easy insertion under a door hinge by reducing frictional contact or by becoming ensnared during the installation process. Thus, the shim may easily slip into the cavity under the hinge without the need for trimming to fit the cavity based on the elongated shape. Additionally, open slot 108 and fold slot 112 are contemplated for use with the hinge screw and may be open to the thin edge to permit the shim to be inserted into the cavity without removing any hinge screw. Further, upon folding or separating a shim 100, shim 200, or shim 300, slot 106 may then become open to an edge and is represented in this configuration as fold slot 112. Rather, the hinge screws can be loosened one and one half turns and the door moved to open the gap under the hinge and the shim(s) placed into the cavity while leaving the screws in place. Next, the hinge screws are tightened.

The shim 100, shim 200, or shim 300 as illustrated in FIGS. 1, 3 and 5, are shown as being molded in sets of three but are contemplated to be molded in sets of any number. This set of three can be folded at the score lines 110, score lines 210, or score lines 310 to provide a thicker, multilayered shim. Each shim is approximately 0.050 inches thick at one end that can move the hinge pin approximately 0.060 inches. Thus, three shims folded together are approximately 0.150 inches thick and will move the hinge pin approximately 0.180 inches. This ability to fold the shims into pairs or a set of three allows for variable and quick adjustment for the alignment of the door. Further, fine adjustments of the hinge can be made by placing the shim 100, shim 200, or shim 300 further into the cavity.

The shims can provide movement of the hinge pin in either direction. Due to the tapered dimensions of the shim, they may be installed either by inserting the thin edge first into the cavity under the hinge or by alternatively inserting the thick edge first. These two options may move the hinge pin in opposite directions. Thus, the thin edge of the shim is inserted first, if the door to jamb gap, which is opposite from the hinge being adjusted, requires reduction. If the gap is too narrow, then the thick edge can be inserted first, thereby moving the hinge pin in the opposite direction and opening the door to jamb gap.

Particular uses and embodiments of the plastic shim have been disclosed. However, other work pieces, especially tapered ones such as a stake and other items particularly those suited for the building industry, could equally be incorporated by use of the same principles described above. Therefore, although preferred embodiments of the present disclosure have been shown and described, various modifications and substitutions may be made thereto without departing from the spirit and scope of the disclosure. It is not intended that these embodiments illustrate and describe all possible embodiments. Rather, the words used in the specification are words of description rather than limitation, and it is understood that various changes may be made without departing from the spirit and scope of the disclosure.

Accordingly, it is not intended that the disclosure be limited except by the appended claims. Insofar as the description above and the accompanying drawings disclose any additional subject matter that is not within the scope of the claims below, the disclosures are not dedicated to the public and the right to file one or more applications to claim such additional embodiments are reserved.

What is claimed is:

1. A hinge shimming device comprising:
a series of connected shims, each of said shims having slots disposed therein, and a thick section terminating along one edge and a thin section along an opposite edge,
wherein the shims are connected at a score line formed by one of the thick edge and the thin edge of one shim, and one of the thin edge and the thick edge of an adjacent shim,
wherein the shims can be separated at the score line by pulling individual shims apart, or the shims can be folded at the score lines while remaining connected, to form a multi-layer shim with overlapping slots,
wherein the slot is one end when the shims are separated at the score lines by pulling apart or folding at the score lines, and
wherein either the thick or thin edge of a hinge shim can be inserted between a hinge pin and a door jamb to permit a user to move the hinge pin closer to or away from the door jamb.

2. The device of claim 1,
wherein the thin edge of each shim terminates in an edge which is acuate.

3. The device of claim 1,
wherein the shims are made of a material selected from the group consisting of polystyrene, polypropylene, and high impact polystyrene.

4. The device of claim 1,
wherein the slots comprise a plurality of slots per shim for hinge mounting screws, wherein the slots are elongated in the direction of the thick and thin edges to permit a shim, including multiple overlapping hinge shims, to be adjusted under a hinge to allow door alignment.

5. The device of claim 1,
wherein the slots comprise two outer slots disposed toward top and bottom edges of each shim, and one center slot disposed centrally between the top and bottom edges.

6. The device of claim 5,
wherein each slot is configured to open to one edge of a shim to permit the shim to be inserted under a hinge without removing the screws of the hinge.

7. The device of claim 1,
wherein said slots comprise slots disposed evenly between the thick and thin edges, and the top and bottom edges of a shim for receiving hinge screws.

8. A composition of connected shims molded in a sheet of a plurality of detachable shims, each of the shims having a thicker edge and an opposite thinner edge,
wherein the shims are connected at a score lines formed by one of the thicker edge and the thinner edge of one shim, and one of the thicker edge and the thinner edge of an adjacent shim,
wherein the shims can be separated cleanly at the score lines by pulling individual shims apart, or the shims can be folded at the score lines while remaining connected, to form a multi-layer shim with overlapping slots, and wherein a series of slots, elongated toward the thicker and thinner edges are disposed in each of the shims,
wherein each slot is configured to open to at least one edge of a shim by the said fold or clean separation, and
wherein either the thicker or thinner edge of one or more hinge shims can be inserted under a hinge to permit a user to move a hinge pin either toward or away from a door jamb.

9. The composition set of claim 8,
wherein the shims are made of a material selected from the group consisting of polystyrene, polypropylene, and high impact polystyrene.

10. The composition of claim 8,
wherein slots are configured to open to at least one edge to permit the hinge shim to be inserted under a hinge without removing a hinge's screws.
